(19) United States
(12) Patent Application Publication
(10) Pub. No.: US 2010/0260179 A1
(43) Pub. Date: Oct. 14, 2010

(54) APPARATUS AND METHOD FOR ADAPTIVE STREAMING OF SCALABLE CONTENTS USING MULTICAST AND UNICAST TRANSMISSION CONCURRENTLY

(75) Inventors: Seong-Jun BAE, Daejeon (KR); Jeong Ju YOO, Daejeon (KR); Jin Woo HONG, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/619,024

(22) Filed: Nov. 16, 2009

(30) Foreign Application Priority Data
Apr. 8, 2009 (KR) 10-2009-0030237

(51) Int. Cl. H04L 12/56

(52) U.S. Cl. 370/390

(57) ABSTRACT

Disclosed is an adaptive transmission device and method of transmitting scalable contents by simultaneously utilizing a multicast transmission and a unicast transmission. The method of transmitting scalable contents in a transmission server includes receiving transmission status information from terminals, determining a transmission policy corresponding to the transmission status of each of the terminals, transmitting a basic transmission group of the scalable contents to the terminals via a multicast or a broadcast, and transmitting an adaptive transmission group of the scalable contents corresponding to the transmission policy to each corresponding terminal via a unicast.

### CROSS-REFERENCE TO RELATED APPLICATION

This application claims the benefit of Korean Patent Application No. 10-2009-0030237, filed on Apr. 8, 2009, in the Korean Intellectual Property Office, the disclosure of which is incorporated herein by reference.

### BACKGROUND

1. Field of the Invention

The present invention relates to an adaptive transmission device and method of transmitting scalable contents by simultaneously utilizing a multicast transmission and a unicast transmission, and more particularly, to an adaptive transmission device and a method that may classify single contents into at least two transmission groups by using a video coding scheme that freely classifies the single contents into a plurality of layers, and may freely select a broadcast transmission scheme, a multicast transmission scheme, or a unicast transmission scheme for each transmission group, thereby constructing an optimal transmission format for each transmission condition and overcoming a weak point of each transmission scheme.

2. Description of the Related Art

There are roughly two schemes used for transmitting contents, namely, a scheme based on one-to-many, such as a broadcast scheme in a conventional broadcasting system and a multicast in the Internet, and a scheme based on one-to-one, such as a unicast scheme. The broadcast scheme transmits contents based on one-to-many. Accordingly, a transmission server is only required to perform a single transmission, and thus, transmission may be efficient, however, the same contents are transmitted to all object terminals, and thus, a used transmission scheme may not appropriately reflect a status of each terminal. Also, the unicast scheme forms an individual transmission channel between each terminal and a transmission sever, and thereby may freely cope with a transmission rate, an error rate, and the like of each channel that may be different for each terminal, however, the transmission server is required to have a separate transmission channel for each terminal that receives a service. Therefore, when the unicast scheme is used for a service for transmission of a large amount of data to many subscribers, extremely large loads may occur in data transmission. The present invention may classify single contents into at least two transmission groups by using a video coding scheme that freely classifies the single contents into a plurality of layers, and may freely select at least one of a broadcast transmission scheme, a multicast transmission scheme, and a unicast transmission scheme for each transmission group, thereby decreasing a load in the server and simultaneously coping with the transmission rate, the error rate, and the like of a channel of each terminal.

### SUMMARY

An aspect of the present invention provides an adaptive transmission device and method of transmitting scalable contents by simultaneously utilizing a multicast transmission and a unicast transmission.

Another aspect of the present invention provides an adaptive transmission device and a method thereof that classifies single contents into at least two transmission groups by using a video coding scheme that freely classifies the single contents into a plurality of layers, and freely selects at least one of a broadcast transmission scheme, a multicast transmission scheme, and a unicast transmission scheme for each transmission group, thereby constructing an optimal transmission format for each transmission condition and overcoming a weak point of each transmission scheme.

Another aspect of the present invention provides an adaptive transmission device and a method thereof where a transmission server transmits only a basic transmission group via a broadcast or a multicast, when transmission status of a terminal is less than a predetermined value.

Another aspect of the present invention provides an adaptive transmission device and a method thereof where a transmission server transmits a basic transmission group via a broadcast or a multicast, and transmits an adaptive transmission group via a unicast, when transmission status of a terminal is greater than or equal to a predetermined value.

According to an aspect of the present invention, there is provided a method of transmitting scalable contents in a transmission server, the method including receiving transmission status information from terminals, determining a transmission policy corresponding to transmission status information of each of the terminals, transmitting a basic transmission group of the scalable contents to the terminals via a multicast or a broadcast, and transmitting an adaptive transmission group of the scalable contents corresponding to the transmission policy to each corresponding terminal via a unicast.

According to another aspect of the present invention, there is provided a method of receiving scalable contents in a terminal, the method including measuring transmission status and transmitting transmission status information to a transmission server, receiving a basic transmission group via a multicast or a broadcast, and providing the scalable contents with a quality that is able to be provided by a most upper layer included in an adaptive transmission group via both the basic transmission group and the adaptive transmission group, when adaptive transmission is received.

According to still another aspect of the present invention, there is provided a transmission server transmitting scalable contents, the transmission server including a transmission contents storing unit to store scalable contents constituted by a plurality of layers, a transmission policy determining unit to receive transmission status information from terminals, and to determine a transmission policy corresponding to the transmission status information of each of the terminals, and an adaptive transmitting unit to transmit, to terminals, a basic transmission group of the scalable contents via at least one of a multicast and a broadcast, and to transmit, to each corresponding terminal, an adaptive transmission group of the scalable contents corresponding to the transmission policy via a unicast.

According to yet another aspect of the present invention, there is provided a terminal receiving scalable contents, the terminal including a transmitting unit to measure transmission status and to transmit transmission status information to a transmission server, a receiving unit to receive a basic transmission group via a multicast or a broadcast, and to receive an adaptive transmission group via a unicast, and a contents replaying unit to provide the scalable contents with a quality that is able to be provided by a most upper layer included in the adaptive transmission group by using the basic transmission group and the adaptive transmission group, when both the basic transmission group and the adaptive transmission are received.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of scalable contents that are hierarchically coded and a bit rate is able to be flexibly and adaptively changed when the contents are transmitted according to embodiments of the present invention;

FIG. 2 is a diagram illustrating a configuration of a transmission server that transmits scalable contents via various transmission schemes based on transmission status of a terminal according to embodiments of the present invention;

FIG. 3 is a flowchart illustrating a process where a transmission server transmits scalable contents via various transmission schemes according to embodiments of the present invention; and

FIG. 4 is a flowchart illustrating a process where a terminal receives scalable contents via various transmission schemes.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Embodiments of the present invention may provide an adaptive transmission device and method thereof that may classify scalable contents that constituted by a plurality of layers, into at least two transmission groups, may select at least one of a broadcast transmission scheme, a multicast transmission scheme, and a unicast transmission scheme for each transmission group, thereby constructing an optimum transmission format based on transmission status.

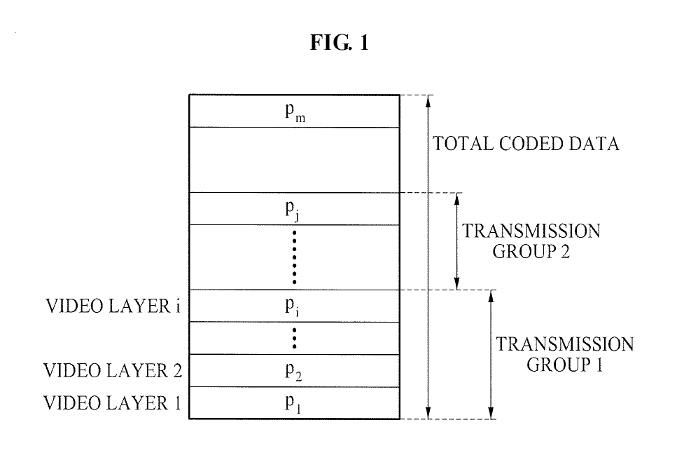

FIG. 1 is a block diagram illustrating a configuration of scalable contents that are hierarchically coded and a bit rate is able to be flexibly and adaptively changed when the contents are transmitted according to embodiments of the present invention.

The scalable contents that are hierarchically coded may form layers based on a level of various qualities, such as a video quality or a voice quality, as illustrated in FIG. 1. In FIG. 1, the scalable contents may have 0 through m quality level layers and each of the layers may be marked by p1 through pm. In this instance, to replay a more excellent quality of an upper layer, a base layer is required. That is, to relay a video quality of a pi layer, p1 layer through pi layer are all required. The scalable contents constituted by the layers may be classified into predetermined groups to form transmission groups. FIG. 1 illustrates an example where the scalable contents are classified into two transmission groups, and in this instance, transmission group 1 transmits p1 through pi layers and transmission group 2 transmits pi+1 through pj layers. In the example of FIG. 1, when the scalable contents is video data, two different video quality levels may be provided, and in this instance, a first video quality provides a level of a case when the transmission group 1 is received, and a second video quality provides an improved video quality level of a case when both the transmission group 2 and the transmission group 1 are received.

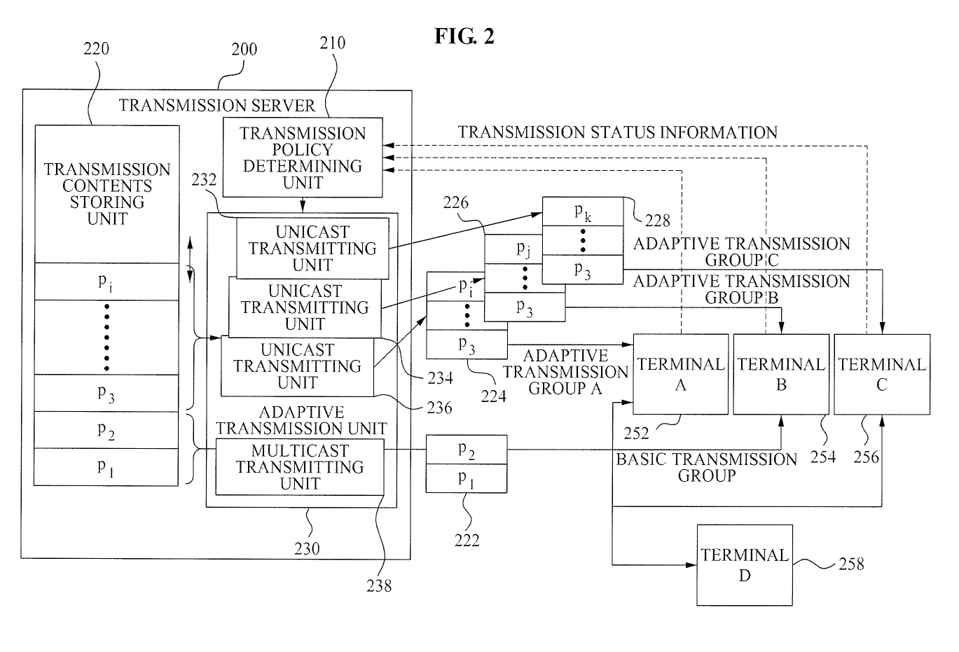

FIG. 2 is a diagram illustrating a configuration of a transmission server 200 that transmits scalable contents via various transmission schemes based on transmission status of a terminal according to embodiments of the present invention.

Referring to FIG. 2, the transmission server 200 may include a transmission policy determining unit 210, an adaptive transmitting unit 220, and a transmission contents storing unit 220.

The transmission contents storing unit 220 may store scalable contents that are constituted by a plurality of layers. The transmission policy determining unit 210 may receive transmission status information from terminals 252, 254, 256, and 258, and may determine transmission policy corresponding to transmission status information of each of the terminals 252, 254, 256, and 258.

In this instance, the transmission policy determining unit 210 may determine to transmit only a basic transmission group when the transmission status of a terminal is less than a predetermined value, based on the transmission status information. Also, the transmission policy determining unit 210 may determine to transmit an adaptive transmission group together with the basic transmission group, the adaptive transmission group including an increasing number of layers as a value of the transmission status increases, when the transmission status of the terminal is greater than or equal to the predetermined value, based on the transmission status information.

Here, the scalable contents are contents constituted by the plurality of layers, and a quality of the scalable contents improves as the contents include contents of an increasingly higher upper layer sequentially from contents of a base layer. The basic transmission group is a minimum group being capable of providing a service of the scalable contents. The adaptive transmission group determines a number of layers to be included in the adaptive transmission group based on the transmission status information, and sequentially includes the determined number of layers which are upper layers higher than layers included in the basic transmission group.

Also, the transmission policy determining unit 210 may adaptively change an amount of data transmitted via the basic transmission group and the adaptive transmission group at a point in time, based on the transmission status information of the terminals 252, 254, 256, and 258 that receive service.

Specifically, the transmission policy determining unit 210 adaptively changes an amount of data transmission of the basic transmission group to maximize the amount of the data transmission, thereby maximizing data to be commonly transmitted common data, and decreasing a load in a network. At the same time, the transmission policy determining unit 210 determines to transmit an amount of data appropriate for each terminal via an adaptive transmission group, even under an individual transmission bandwidth condition.

The adaptive transmission unit 220 may include a multicast transmission unit 238 that transmits the basic transmission group 222 to all terminals via a multicast, and unicast transmission units 232, 234, and 236 that transmit adaptive transmission groups 224, 226, and 228 corresponding to the transmission policy to each corresponding terminal via a unicast.

In this instance, the basic transmission group may also perform transmission via a broadcast. The terminals 252, 254, 256, and 258 may include a transmitting unit, a receiving unit, and a contents replaying unit.

In this instance, the transmitting unit may measure transmission status and may transmit transmission status information to the transmission server. The receiving unit may receive the basic transmission group via the multicast or the broadcast, and may receive the adaptive transmission group via the unicast.

Also, the contents replaying unit may provide the scalable contents with a quality that is able to be provided by a most upper layer included in the adaptive transmission group via both the basic transmission group and the adaptive transmission group, when the basic transmission group and the adaptive transmission are all received. However, the contents replaying unit may provide the scalable contents with a quality that is able to be provided by a most upper layer included in the basic transmission group, when only the basic transmission group is received.

Hereinafter, an adaptive transmission method of the scalable contents by simultaneously utilizing the multicast transmission and the unicast transmission will be described in detail with reference to drawings.

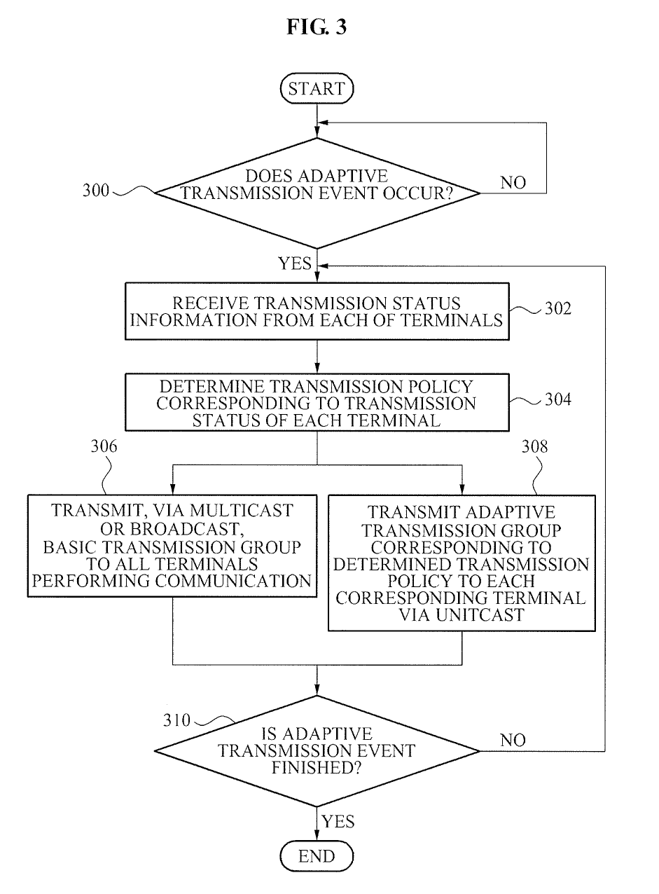

FIG. 3 is a flowchart illustrating a process where a transmission server transmits scalable contents via various transmission schemes according to embodiments of the present invention.

Referring to FIG. 3, when the transmission server senses that an adaptive transmission event occurs in operation 300, the transmission server performs operation 302 to receive transmission status information from terminals, and performs operation 304 to determine a transmission policy corresponding to transmission status of each terminal.

In this instance, based on the transmission status information, the transmission server may determine to transmit only a basic transmission group when the transmission status of the terminal is less than a predetermined value, and may determine to transmit both the basic transmission group and an adaptive transmission group, the adaptive transmission group including a increasing number of layers as a value of the transmission status is higher.

Here, the scalable contents are contents constituted by a plurality of layers, and a quality of the scalable contents improves as the contents include contents of an increasingly higher upper layer sequentially from contents of a base layer. The basic transmission group is a minimum group being capable of providing a service of the scalable contents. The adaptive transmission group determines a number of layers to be included in the adaptive transmission group based on the transmission status information, and sequentially includes the determined number of layers which are upper layers higher than layers included in the basic transmission group.

Subsequently, the transmission server performs operation 306 to transmit, via a multicast or a broadcast, the basic transmission group to all terminals performs communication. Also, the transmission server simultaneously performs operations 306 and 308 to transmit the adaptive transmission group corresponding to each determined transmission policy to each terminal corresponding to the determined transmission policy via a unicast.

After operations 306 and 308, the transmission server performs operation 310 to determine whether the adaptive transmission event is finished. As a result of the determination in operation 310, when the adaptive transmission event is not completed, the transmission server returns to operation 302 to repeatedly perform a series of operations, and as a result of the determination in operation 310, when the adaptive transmission event is completed, the transmission server completes the present algorithm.

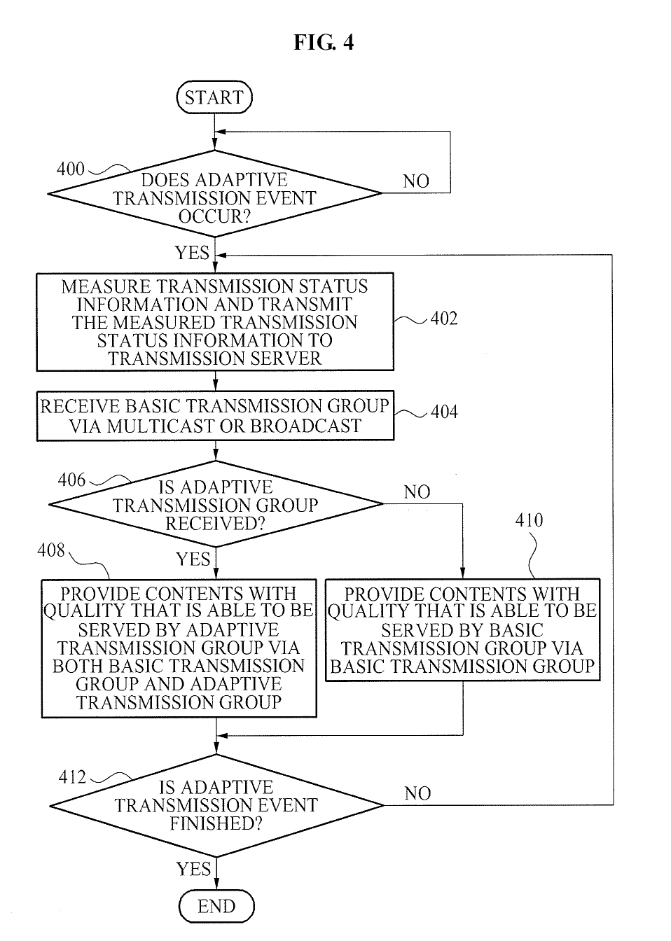

FIG. 4 is a flowchart illustrating a process where a terminal receives scalable contents via various transmission schemes.

Referring to FIG. 4, when the terminal senses that an adaptive transmission event occurs in operation 400, the terminal performs operation 402 to measure transmission status and to transmit transmission status information, then performs operation 404 to receive a basic transmission group via a multicast or a broadcast, and then performs operation 406 to determine whether an adaptive transmission group is received.

As a result of determination in operation 406, when the adaptive transmission group is received, the terminal provides contents with a quality that is able to be provided by the adaptive transmission group via both the transmission group and the adaptive transmission group, and performs operation 412.

However, as the result of the determination in operation 406, when the adaptive transmission group is not received, the terminal performs operation 410 to provide contents with a quality that is able to be provided by the basic transmission group only via the basic transmission group, and performs operation 412.

Subsequently, the terminal proceeds with operation 412 to determined whether the adaptive transmission event is finished. As a result of the determination in operation 412, when the adaptive transmission event is not completed, the terminal returns to operation 402 to repeatedly perform a series of operations, and as a result of the determination in operation 412, when the adaptive transmission event is completed, the terminal completes the present algorithm.

The present invention relates to an adaptive transmission device and a method that may classify single contents constituted by a plurality of layers into at least two transmission groups, and may select at least one of a broadcast transmission scheme, a multicast transmission scheme, and a unicast transmission scheme for each transmission group, thereby constructing an optimal transmission format for each transmission status. The adaptive transmission device and the method may adaptively select a transmission scheme to provide contents with a quality that is able to be provided based on transmission status of a terminal, thereby providing contents with an optimal quality for each terminal. Also, the adaptive transmission device and the method may maximize data transmission of a basic transmission group that is commonly serviced based on transmission status of terminals, thereby decreasing a load in communication network.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of transmitting scalable contents in a transmission server, the method comprising:
receiving transmission status information from terminals;
determining a transmission policy corresponding to transmission status information of each of the terminals;
transmitting a basic transmission group of the scalable contents to the terminals via a multicast or a broadcast; and
transmitting an adaptive transmission group of the scalable contents corresponding to the transmission policy to each corresponding terminal via a unicast.

2. The method of claim 1, wherein the determining of the transmission policy determines to transmit only the basic transmission group when the transmission status of each of the terminals is less than a predetermined value, based on the transmission status information.

3. The method of claim 1, wherein the determining of the transmission policy determines to transmit the adaptive transmission group together with the basic transmission group, the adaptive transmission group including an increasing number of layers as a value of the transmission status increases, when the transmission status of each of the terminals is greater than or equal to a predetermined value, based on the transmission status information.

4. The method of claim 1, wherein the scalable contents are contents constituted by a plurality of layers, and a quality of the scalable contents improves as the contents include contents of an increasingly higher upper layer sequentially from contents of a base layer.

5. The method of claim 1, wherein the basic transmission group is a minimum group being capable of providing a service of the scalable contents.

6. The method of claim 1, wherein the adaptive transmission group determines a number of layers to be included in the adaptive transmission group based on the transmission status information, and sequentially includes the determined number of layers which are upper layers higher than layers included in the basic transmission group.

7. A method of receiving scalable contents in a terminal, the method comprising:
measuring transmission status and transmitting transmission status information to a transmission server;
receiving a basic transmission group via a multicast or a broadcast; and
providing the scalable contents with a quality that is able to be provided by a most upper layer included in an adaptive transmission group via both the basic transmission group and the adaptive transmission group, when adaptive transmission is received.

8. The method of claim 7, further comprising:
providing the scalable contents with a quality that is able to be provided by a most upper layer included in the basic transmission group via the basic transmission group, when the adaptive transmission group is not received.

9. The method of claim 7, wherein the scalable contents are contents constituted by a plurality of layers, and a quality of the scalable contents improves as the contents include contents of an increasingly higher upper layer sequentially from contents of a base layer.

10. The method of claim 7, wherein the basic transmission group is a minimum group being capable of providing a service of the scalable contents.

11. The method of claim 7, wherein the adaptive transmission group determines a number of layers to be included in the adaptive transmission group based on the transmission status information, and sequentially includes the determined number of layers which are upper layers higher than layers included in the basic transmission group.

12. A transmission server transmitting scalable contents, the transmission server comprising:
a transmission contents storing unit to store scalable contents constituted by a plurality of layers;
a transmission policy determining unit to receive transmission status information from terminals, and to determine a transmission policy corresponding to the transmission status information of each of the terminals; and
an adaptive transmitting unit to transmit, to terminals, a basic transmission group of the scalable contents via at least one of a multicast and a broadcast, and to transmit, to each corresponding terminal, an adaptive transmission group of the scalable contents corresponding to the transmission policy via a unicast.

13. The server of claim 12, wherein the transmission policy determining unit determines to transmit only the basic transmission group when the transmission status of each of the terminals is less than a predetermined value, based on the transmission status information.

14. The server of claim 12, wherein the transmission policy determining unit determines to transmit the adaptive transmission group together with the basic transmission group, the adaptive transmission group including an increasing number of layers as a value of the transmission status increases, when the transmission status of each of the terminals is greater than or equal to a predetermined value, based on the transmission status information.

15. The server of claim 12, wherein the scalable contents are contents constituted by a plurality of layers, and a quality of the scalable contents improves as the contents include contents of an increasingly higher upper layer sequentially from contents of a base layer.

16. The server of claim 12, wherein the basic transmission group is a minimum group being capable of providing a service of the scalable contents.

17. The server of claim 12, wherein the adaptive transmission group determines a number of layers to be included in the adaptive transmission group based on the transmission status information, and sequentially includes the determined number of layers which are upper layers higher than layers included in the basic transmission group.

18. The server of claim 12, wherein the transmission policy determining unit changes an amount of data that is transmitted via the basic transmission group, based on the transmission status information of the terminals.

19. A terminal receiving scalable contents, the terminal comprising:
a transmitting unit to measure transmission status and to transmit transmission status information to a transmission server;
a receiving unit to receive a basic transmission group via a multicast or a broadcast, and to receive an adaptive transmission group via a unicast; and
a contents replaying unit to provide the scalable contents with a quality that is able to be provided by a most upper layer included in the adaptive transmission group by using the basic transmission group and the adaptive transmission group, when both the basic transmission group and the adaptive transmission are received.

20. The terminal of claim 19, wherein the contents replaying unit provides the scalable contents with a quality that is able to be provided by a most upper layer included in the basic transmission group, when the basic transmission group is only received through the receiving unit.

21. The terminal of claim 19, wherein the scalable contents are contents constituted by a plurality of layers, and a quality of the scalable contents improves as the contents include contents of an increasingly higher upper layer sequentially from contents of a base layer.
